(19) United States
(12) Patent Application Publication
(10) Pub. No.: US 2010/0174704 A1
(43) Pub. Date: Jul. 8, 2010

(54) SEARCHING METHOD AND SYSTEM

(76) Inventors: Fabio Ciravegna, Sheffield South Yorkshire (GB); Samuel John Chapman, Sheffield South Yorkshire (GB); Ravish Bhagdev, Sheffield South Yorkshire (GB); Vitaveska Lanfranchi, Sheffield South Yorkshire (GB); Daniela Petrelli, Sheffield South Yorkshire (GB)

Correspondence Address: GOTTLIEB RACKMAN & REISMAN PC, 270 MADISON AVENUE, 8TH FLOOR, NEW YORK, NY, 10016-0601, US

(21) Appl. No.: 12/601,911

(22) PCT Filed: May 23, 2008
(86) PCT No.: PCT/GB08/50376

§ 371 Date: Dec. 24, 2009

(30) Foreign Application Priority Data
May 25, 2007 (GB) 0710073.8

(51) Int. Cl. G06F 17/30

(52) U.S. Cl. 707/722; 707/E17.014; 707/769

(57) ABSTRACT

A method of providing a search result, comprising combining a result of a keyword search on a plurality of documents with a result of a semantic search on the plurality of documents; and providing a result of the combining.

### FIELD OF THE INVENTION

Embodiments of this invention relate to a searching method and system.

### BACKGROUND TO THE INVENTION

Large organizations often store documents on internal networks known as intranets. A typical intranet may connect thousands of computers and reach the size of dozens of millions of documents. A document is typically located in an intranet using a keyword search. A user specifies one or more keywords, and the search result indicates the documents that contain all of the keywords. Using a keyword search to locate a document from such a large number of documents can have a number of drawbacks, for example:
homonyms—the same word can have different meanings, e.g. bank (river or financial) or an ambiguous name such as J. Smith. Therefore, a keyword may cause the search to return documents that are not relevant.
synonyms—a concept that can be described by more than one word or expression, e.g. New York and Big Apple. Therefore, a keyword may miss certain relevant documents.

When coping with large organisation intranets, the issue of synonyms is more complex than the issue of homonyms, because different communities can use different sub-languages and terminologies, making the problem of modelling or dealing with synonyms quite complex. Keyword searching can face the following issues:
Sub-language—domain specific documents tend to use limited vocabularies that are further reduced by technical sub-languages; this limited number of relevant words tends to be reused in different contexts. For example, 6,000 words may be used to describe 25,000 components; for example “gasket ring” and “ring gasket” may represent two different objects using the same words. Keyword-based search struggles to cope with such problems.
Quantitative analysis—an example of a question that a user might want to ask when searching is “what are the issues identified on the Nozzle Guide Vane of engine class R123A during service in the current year and what was the impact on the customer?”. There is no way to answer this question using a keyword search as this requires analysis of the content of documents, which is not supported by a keyword search.
Context modelling—very often it is the context of a document that determines the relevancy of a piece of text in the document. This is particularly true for Knowledge Management in technical domains. For example, when searching for cracks on the nozzle guide vane, the query “cracks” and “Nozzle Guide Vane” would return any document containing the two terms, including the ones where the cracks are not on the nozzle guide vane. Very often with keyword search results in intranets, the number of irrelevant documents is far larger than that of relevant documents.
Lack of interconnections across archives and media—very often information is spread across media and archives. While it is possible to perform queries on multiple archives, it is impossible to merge the results; reading all the documents and connecting the information manually is still necessary.
Long tail distribution and redundancy of information—traditional text retrieval methods rank all documents containing the same keywords the same with respect to a query. This means that, following the 80-20 rule, 80% of the documents will concern 20% of the issues. A keyword search may be very effective in retrieving documents relevant to those issues. However, it tends to perform less well for the other 80% of the issues that are not very frequent. The goal of Knowledge Management is very often to focus on the new and emerging issues, which are quite infrequent. This means that the user of a system will have to read a large number of irrelevant documents returned by a keyword search in order to manually identify the very small sets of relevant ones.

For the above reasons, there is a growing interest in applying Semantic Web methodologies to the search process via the association of formal metadata, making the document content (as opposed to its keywords) available to automatic processing. This enables semantic searching using an ontology: the ontology is usually used both for annotating the documents and for retrieving them. An ontology may comprise, for example, a data structure that identifies documents in an intranet and provides information about the content in each document. For example, an ontology may identify a document and specify the serial numbers of the components described within that document and may identify a date of an issue described in the document. A semantic search has the ability to:
overcome the problems of synonymy and polysemy (where a single word can have multiple meanings), as the formal definition (ontology) is unambiguous and uniquely identifies objects;
provide multiple ontologies modelling different views on the domain; different communities can use different views on the domain and still retrieve relevant information;
model the context: the ontology can easily model the context in which the information is captured via ontology-based logical statements;
connect information across media and archives, when the same ontology is used to annotate the different resources and media;
enable quantitative analysis of facts; the query “what are the issues identified on the Nozzle Guide Vane of engine class R123A during service in the current year and what was the impact on the customer” can be easily answered if the ontology is available and indicates, for example, the documents that concern a nozzle guide vane, the engine class and the issue date, and maybe also the customer impact.

However, semantic search methods may have problems because of:
lack of freedom; they constrain users to the use of an ontology that may impose a pre-fixed view of the domain. therefore, a user may be restricted in terms of the types of information that can be searched or using a semantic search.
lack of intuitiveness; users very often have problems in manipulating logical languages. keyword searching tends to be more natural for the user.
their cost; the generation of an ontology can be very expensive if performed manually; some approaches try to generate data automatically or semi-automatically.
quality of the ontology; both manual and automatic ontology generation is an error prone process. Relying on imprecise metadata can imply some risks.

It is an object of embodiments of the invention to at least mitigate one or more of the problems of the prior art.

### SUMMARY OF THE INVENTION

According to a first aspect of embodiments of the invention, there is provided a method of providing a search result, comprising combining a result of a keyword search on a plurality of documents with a result of a semantic search on the plurality of documents; and providing a result of the combining.

Thus it is possible to perform a search that combines the benefits of both keyword searching and semantic searching. For example, a user may provide one or more keyword search terms, which may be a simple and/or intuitive task for the user, while at the same time providing one or more semantic search terms to improve the quality of the results returned. The semantic search terms may be provided, for example, in a manner similar to the provision of keyword search terms, such that provision of semantic search terms may also be a simple and/or intuitive task for the user.

In certain embodiments, combining the results comprises determining documents that are indicated in both the result of the keyword search and the result of the semantic search; and providing the result of the combining comprises providing an indication of such documents. Therefore, for example, the results returned are those documents that contain specified keywords and also meet specified semantic criteria. The search result may be of higher quality than, for example, a simple keyword search, as the documents returned are only those relevant documents according to the semantic search criteria. The search result may be of higher quality than, for example, a semantic search, as the flexibility of using keywords to perform the search is included.

In certain embodiments, the method comprises performing a keyword search on the plurality of documents to obtain the result of the keyword search. Performing a keyword search may comprise using an index to determine documents that contain keyword search terms. Thus, for example, using the index to perform the keyword search may be faster and/or less resource intensive than searching all of the documents for each keyword search. Preferably, the index comprises an inverted index. In certain embodiments, the method comprises producing the index from the plurality of documents. Thus, the documents only need to be parsed once, or relatively few times, to create the index and/or keep the index up to date.

In certain embodiments, the method comprises performing a semantic search on the plurality of documents to obtain the result of the semantic search. Performing a semantic search may comprise using metadata associated with the plurality of documents to determine documents that contain semantic search terms. Thus, for example, the documents themselves do not have to be searched to determine whether they meet the semantic search criteria, which may be a time consuming and/or resource intensive and/or error-prone process. Instead, the metadata is used, which provides semantic information relating to the documents and which can be searched in a semantic search instead of the documents. In certain embodiments, the method comprises producing the metadata from the plurality of documents.

In certain embodiments, the method comprises obtaining one or more keyword search terms and one or more semantic search terms from a user via at least one user interface; performing a keyword search on the plurality of documents using the keyword search terms to obtain the result of the keyword search; and performing a semantic search on the plurality of documents using the semantic search terms to obtain the result of the semantic search. Thus, for example, a user interface may be used by a user to specify keyword search terms and semantic search terms (semantic search criteria), possibly simultaneously.

According to a second aspect of embodiments of the invention, there is provided a method of performing a search, comprising providing an indication of one or more documents from a plurality of documents that contain one or more keywords and meet semantic search criteria.

According to a third aspect of embodiments of the invention, there is provided a system for providing a search result, comprising means for combining a result of a semantic search on a plurality of documents and a result of a keyword search on the plurality of documents to determine the search result.

### BRIEF DESCRIPTION OF THE DRAWINGS

Embodiments of the invention will now be described by way of example only, with reference to the accompanying drawings, in which:

FIG. 1 shows a system according to embodiments of the invention;

FIG. 2 shows a system according to embodiments of the invention; and

FIG. 3 shows a method according to embodiments of the invention.

### DETAILED DESCRIPTION OF EMBODIMENTS OF THE INVENTION

Embodiments of the invention combine the benefits of a keyword search and a semantic search by effectively performing both searches on a single set of documents (such as a plurality of documents in an intranet). For example, a semantic search may be performed to obtain a semantic search result, and a keyword search may be performed to obtain a keyword search result. The semantic search result and the keyword search result may be combined to provide a search result that includes the benefits of both keyword based searching and semantic searching. For example, a user may find it natural to provide keywords for the search, and may also provide semantic information to improve the relevancy (and, therefore, quality) of the search results. The semantic search results and the keyword search results may be combined, for example, by identifying the documents that appear in both search results.

Alternatively, for example, in embodiments of the invention the semantic search and the keyword search may be performed simultaneously and just once on a single set of documents, the result of the searches providing combined search results that are the results of the combined search.

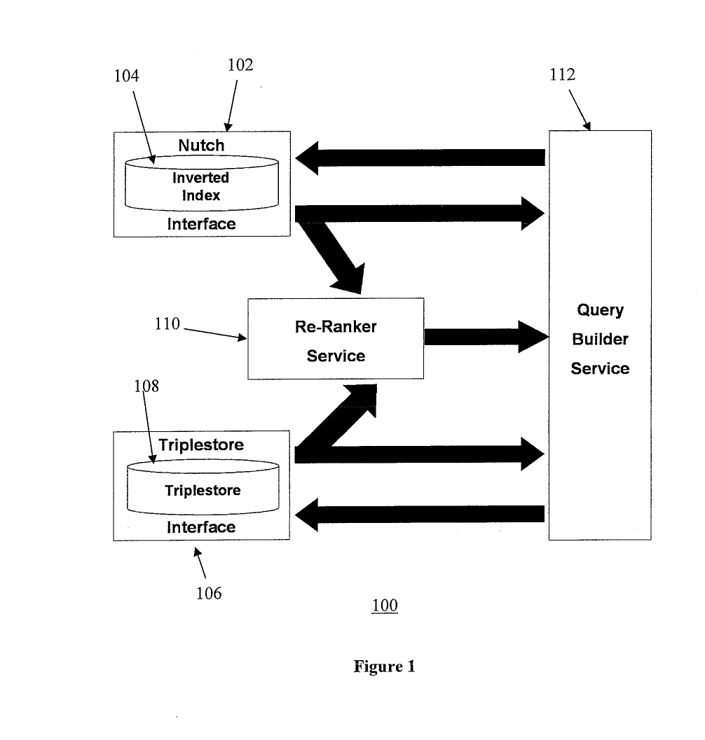

FIG. 1 shows an example of a system 100 for providing a search result according to embodiments of the invention. The system 100 includes a Nutch interface 102 that serves as an interface with an inverted index 104. Nutch (http://lucene.apache.org/nutch/) is web-search software that provides an interface for a keyword search in a number of web-based documents, although it can also be used to search within other documents (such as, for example, those located on an intranet). The inverted index 104 comprises an index that provides a list of keywords located within documents and indicates the documents in which they are located. The Nutch interface 102 performs a keyword search on the set of documents by searching for the keywords within the inverted index 104. This method of searching is generally faster than searching all of the documents for the keywords for every keyword search. The inverted index may be created from the set of documents, for example, using the Nutch software or otherwise. In alternative embodiments of the invention, a different type of index 104 or a different interface 102 may be used for keyword searching. For example, Lucene (http://www.openrdf.org) may be used for the index and/or interface.

The system 100 also includes a triplestore interface 106 that serves as an interface with triplestore data 108. The triplestore data 108 comprises a plurality of statements that describe metadata relating to the set of documents. For example, the metadata may indicate which documents describe which components, and so on. Thus, the metadata describes the ontology of the set of documents. A triplestore statement includes a subject, an object and a relation between the object and subject, and may have a form that is represented by {subject, relation, object}, for example.

For example, it may be desired to express a relationship in the form of {subject, relation, object, uri} where the uri (universal resource indicator) indicates (for example, identifies) a document or multiple documents. For example, subject might be a component, the object might be a component number the relation might be “equals”. Therefore, this relationship indicates a document that has a component number equal to a certain value (given as the object).

A triplestore is not able to express this relationship in a single statement. Therefore, the triplestore 108 may contain two corresponding statements:
{subject, has_property, object}
   and
{subject, has_source, uri}
   where has_property may mean “equals” when the object is a component number, and has_source indicates a uri associated with the subject. In alternative embodiments, the triplestore data 108 may express the relationships in other ways. For example, the relationship {subject, has_source, uri} may be replaced by or used in addition to the relationship {object, has_source, uri}. In further alternative embodiments, however, the triplestore data 108 may be replaced by or used in addition to some other data that expresses the content and/or context of the documents, or the triplestore 108 may be able to express the relationship {subject, relation, object, uri}, for example.

The triplestore 108 may be expressed, for example, as an XML data structure. In particular, the triplestore data 108 may be expressed as a RDF (Resource Description Framework) data structure that may be used to model triplestore statements that describe metadata. Query languages, such as, for example, SPARQL (SPARQL Protocol and RDF Query Language) may be used to perform queries (searches) on the metadata in the triplestore data 108. Specifications describing XML, RDF, SPARQL, OWL and any other standards that may be used with embodiments of the invention are incorporated herein by reference for all purposes.

The triplestore interface 106 provides an interface for performing a semantic search and may use query languages (for example SPARQL) to perform semantic searches.

In alternative embodiments of the invention, the triplestore data 108 may be replaced by some other metadata structure, and/or the triplestore interface 106 may be replaced by some other interface.

The system 100 also includes a re-ranker service 110. The re-ranker service 110 combines a keyword search result from the Nutch interface 102 with a semantic search result from the triplestore interface 106. For example, the re-ranker service 110 identifies the documents that are common to both the keyword search result and the semantic search result, and provides these documents (or an indication thereof) as a search result.

The system 100 further comprises a query builder service 112. The query builder service 112 acts as a “front end” for the system 100. A user may pass keywords and semantic search terms (for example via a user interface) to the query builder service 112, and the query builder service 112 builds queries for the interfaces 102 and 106 such that the interfaces carry out the appropriate searches. For example, the query builder service may construct a SPARQL query using semantic search terms and pass the query to the triplestore interface 106. The query builder service 112 also receives a search result (being a result of the combined keyword and semantic searches) from the re-ranker service 110. The query builder service 112 may also pass the search result to an appropriate party (such as, for example, the user).

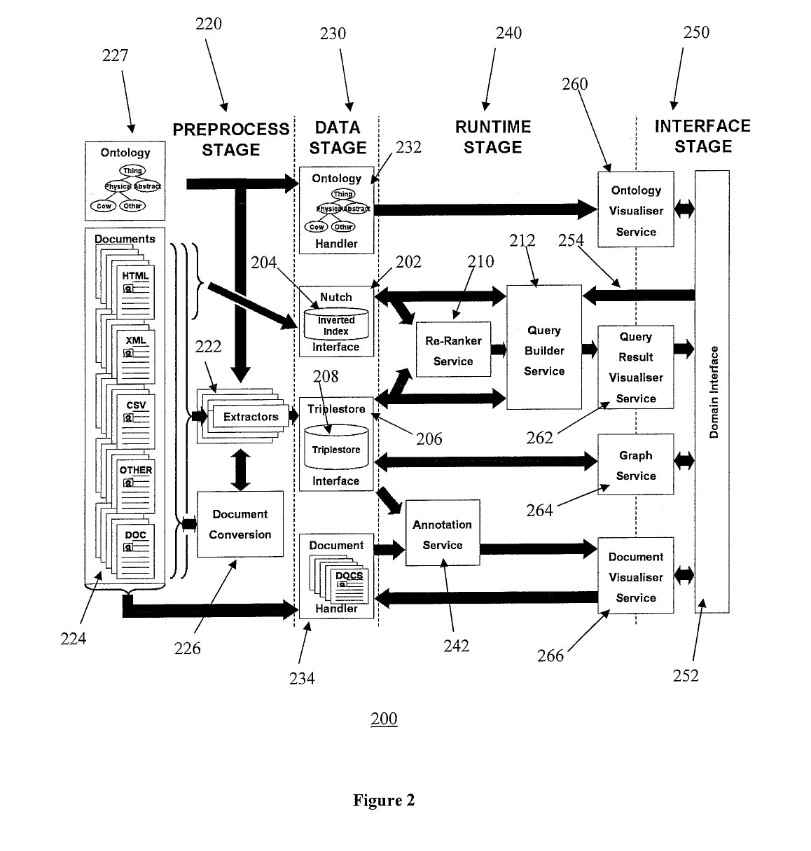

FIG. 2 shows an embodiment of a system 200 for providing a search result according to embodiments of the invention in more detail. The system 200 comprises a Nutch interface 202, inverted index 204, triplestore interface 206, triplestore data 208, re-ranker service 210 and query builder service 212. These components may be similar to those shown in the system 100 of FIG. 1.

The system 200 also includes a preprocess stage 220 that is used to obtain the inverted index 204 and/or the triplestore data 208, which may be obtained before the query builder service 212 is used to carry out a search according to embodiments of the invention. The preprocess stage 220 includes extractors 222 that extract information from a set 224 of documents (also known as a corpus) in order to build the inverted index 204 and the triplestore data 208. (Alternatively, the extractors may provide appropriate information to the Nutch interface 202 and/or triplestore interface 206 such that the interfaces build the appropriate databases.) The preprocess stage 220 may include document converters 226 that convert the documents 224 into a more appropriate format for use by the extractors 222. The extractors 222 may also have access to a predefined ontology structure 227 which can be used to build the triplestore data 208. Methods and systems for building the inverted index 204 and/or the triplestore data 208 are indicated in the appendices to this description, in particular in appendix 1, section 4.1.1. The ontology may be represented by a suitable ontology language such as, for example, Web Ontology Language (OWL).

The system 200 further includes a data stage 230, which includes the Nutch interface 202, inverted index 204, triplestore interface 206 and triplestore data 208. The data stage 230 also includes an ontology handler 232 and a document handler 234, which are explained in more detail later in this description.

The system 200 also comprises a runtime stage 240 that includes the re-ranker service 210 and query builder service 212. The runtime stage 240 also includes an annotation service 242 that accepts an indication of a document from the document handler 232 and retrieves annotations associated with the document from the triplestore data 208 via the triplestore interface 206.

The system 200 also includes an interface stage 250 that includes a user interface 252. The user interface 252 serves as an interface through which a user can provide keywords and semantic search terms to the query builder service 212 in the form of a query 254.

The system 200 further comprises an ontology visualiser service 260, query result visualiser service 262, graph service 264 and document visualiser service 266. The ontology visualiser service 260 provides information to the user interface 252 such that the user interface 252 can display, at the request of a user, all or part of the ontology 227 which is obtained via the ontology handler 232. The query result visualiser service 262 provides a search result according to embodiments of the invention to the user interface 252 in a form that can be displayed by the user interface 252. The graph service 264 is used to build visual displays of the last search result returned by the query builder service 212 according to specified criteria. So, for example, the last search result can be grouped in terms of author (and/or any other criteria) and viewed. The document visualiser service 266 presents a document to the user interface 252 in a form that can be displayed by the user interface, and may also highlight search terms and/or annotations from the annotation service 242, for example.

In the systems described above, the triplestore data 208 and/or the index 204 may be stored, for example, on one or more file systems, file stores, memories and/or some other storage.

Some or all of the systems and/or parts of the systems shown in FIGS. 1 and 2 may be explained in more detail in the attached appendices.

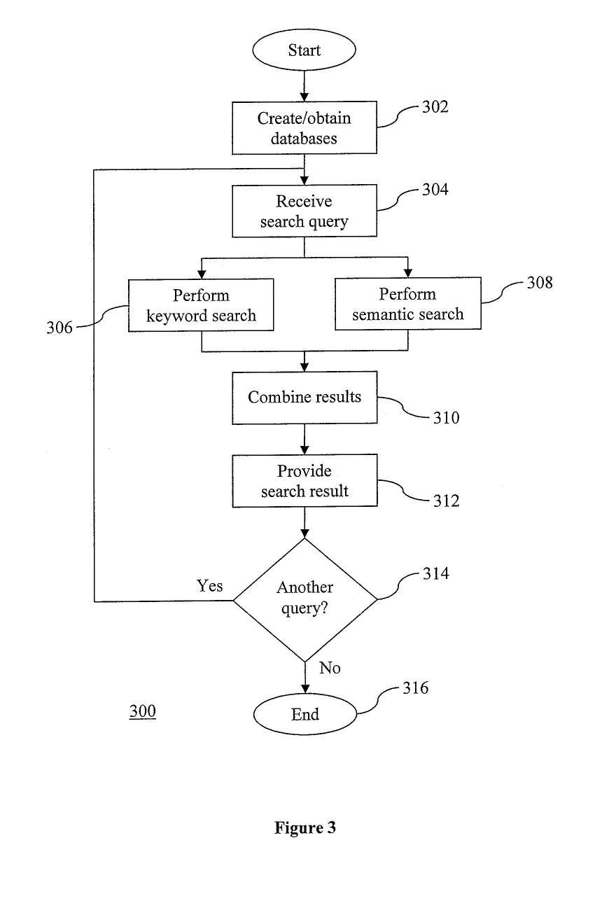

FIG. 3 shows an example of a method 300 of providing a search result according to embodiments of the invention. The method 300 starts at step 302 where the databases (for example, the inverted index and/or the triplestore data) used by embodiments of the invention are created and/or obtained. Next, in step 304, a search query is received from, for example, a user using a user interface. The search query may include one or more keyword search terms and/or one or more semantic search terms. Then, in step 306, the keyword search is performed to obtain the keyword search result, and in step 308, the semantic search is performed to obtain the semantic search result. Steps 306 and 308 are independent of each other and so may be performed in either order or in parallel. Once steps 306 and 308 are complete, the keyword search result and the semantic search result are combined in step 310 to produce a search result. Alternatively, in certain embodiments of the invention, steps 306, 308 and 310 may be replaced by a single combined semantic and keyword search that provides a combined search result.

Then, in step 312, the combined search result is provided to, for example, a user interface and/or a search result handler such as the query builder service 112. Next, in step 314, it is determined whether there is another query for a search from the user. If there is another query, then the method 300 returns to step 304, whereas if there is not another query, the method 300 ends at step 316.

The combined search result may comprise, for example, a list of the uris of documents. The results may be ordered, or ranked, according to, for example, the order or ranking provided by the keyword search result, as existing interfaces (for example Nutch) may provide such ranking. However, other ordering or ranking methodologies may instead be used, and/or the combined search result may be of any suitable alternative format.

In the above description, documents are files that are stored on one or more file systems associated with one or more data processing systems, or stored other wise such in data stores, memory and/or other stores. However, in alternative embodiments of the invention, a document may comprise some other entity and may even comprise a part of another document or multiple documents.

In alternative embodiments of the invention, a search may be performed (using, for example, the documents and/or one or more databases associated with the documents) using a single search interface, rather than separate search interfaces for a keyword and semantic search. Therefore, only a single search query needs to be evaluated. The search query may return or indicate documents that, for example, meet both keyword search criteria and semantic search criteria. However, use of a single search interface may preclude the use of some existing technologies such as, for example, SPARQL, or may require the technologies to be modified.

In the above, the metadata describes ontology-based information. However, in alternative embodiments of the invention, the metadata may describe some other information such that the semantic search can be carried out. Metadata may describe, for example, a document's context (such as, for example, the author and/or title) and a document's content (such as, for example, the components described, the issues involved, and/or other content).

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of providing a search result, comprising:
combining a result of a keyword search on a plurality of documents with a result of a semantic search on the plurality of documents; and
providing a result of the combining.

2. A method as claimed in claim 1, wherein combining comprises
determining documents that are indicated in both the result of the keyword search and the result of the semantic search; and
providing the result of the combining comprises providing an indication of such documents.

3. A method as claimed in claim 1, comprising performing a keyword search on the plurality of documents to obtain the result of the keyword search.

4. A method as claimed in claim 3, wherein performing a keyword search comprises using an index to determine documents that contain keyword search terms.

5. A method as claimed in claim 4, wherein the index comprises an inverted index.

6. A method as claimed in claim 4, comprising producing the index from the plurality of documents.

7. A method as claimed in claim 1, comprising performing a semantic search on the plurality of documents to obtain the result of the semantic search.

8. A method as claimed in claim 7, wherein performing a semantic search comprises using metadata associated with the plurality of documents to determine documents that contain semantic search terms.

9. A method as claimed in claim 8, comprising producing the metadata from the plurality of documents.

10. A method as claimed in claim 1, comprising
obtaining one or more keyword search terms and one or more semantic search terms from a user via at least one user interface;
performing a keyword search on the plurality of documents using the keyword search terms to obtain the result of the keyword search; and
performing a semantic search on the plurality of documents using the semantic search terms to obtain the result of the semantic search.

11. A method of performing a search, comprising providing an indication of one or more documents from a plurality of documents that contain one or more keywords and meet semantic search criteria.

12. A system for providing a search result, comprising means for implementing a method as claimed in claim 1.

13. A system for providing a search result, comprising means for combining a result of a semantic search on a plurality of documents and a result of a keyword search on the plurality of documents to determine the search result.

14. A system as claimed in claim 13, comprising keyword search means for performing a keyword search on the plurality of documents to obtain the result of the keyword search.

15. A system as claimed in claim 14, wherein the keyword search means comprises means for using an index to perform the keyword search.

16. A system as claimed in claim 15, comprising a keyword extractor for producing the index from the plurality of documents.

17. A system as claimed in claim 13, comprising semantic search means for performing a semantic search on the plurality of documents to obtain the result of the semantic search.

18. A system as claimed in claim 17, wherein the semantic search means comprises means for using metadata to perform the semantic search.

19. A system a claimed in claim 18, comprising a metadata extractor for producing the metadata from the plurality of documents.

20. A system as claimed in claim 13, comprising a user interface for receiving at least one of at least one keyword search term and at least one semantic search term.

21. A system as claimed in claim 13, wherein the means for combining comprises means for determining documents that are common to the result of the keyword search and the result of the semantic search.

22. A computer program for implementing a method as claimed in claim 1.

23. Computer readable storage storing a computer program as claimed in claim 22.

24. A data processing system having loaded therein a computer program as claimed in claim 22.

25. (canceled)
